(19) United States
(12) Patent Application Publication
(10) Pub. No.: US 2023/0016354 A1
(43) Pub. Date: Jan. 19, 2023

(54) LOW FRICTION SEAL ASSEMBLY FOR TRUCK HUBS

(71) Applicant: AKTIEBOLAGET SKF, Goteborg (SE)

(72) Inventor: Rico Dittmar, Schweinfurt (DE)

(21) Appl. No.: 17/373,941

(22) Filed: Jul. 13, 2021

(51) Int. Cl. F16C 33/80; F16J 15/3264

(52) U.S. Cl. CPC F16C 33/805; F16J 15/3264; F16C 2326/02

(57) ABSTRACT

A seal assembly is for a wheel hub assembly and includes an inner annular case disposable about an axle and having a radial portion extending radially outwardly from the axle. An outer annular case is coupleable with a hub bore and has a radial portion extending radially inwardly from the bore. An annular elastomeric seal member has a base portion disposed on the outer case and at least one flexible axial seal lip with a first end integrally formed with the base portion and a second, free end sealingly engageable with the radial portion of the inner case. The lip extends generally axially and radially outwardly from the first end to the second end such that the lip is biased radially outwardly by centrifugal force during rotation of the hub to reduce sealing pressure of the lip second end on the inner case radial portion.

### BACKGROUND OF THE INVENTION

The present invention relates to seals, and more particularly to seals for wheel hub assemblies.

Wheel hub assemblies, particularly for mounting wheels to vehicles such as trucks, typically include an inner axle connected with a vehicle frame, an outer hub connectable to the wheel, and a bearing for rotatably coupling the hub with the axle. The bearings are often double-row tapered rollers disposed between the outer hub and the inner axle and enable the hub, and thereby the wheel, to rotate about a central axis extending through the fixed axle. As such bearings are generally exposed to contaminants such as brake dust, dirt, oil, metal shavings, etc., which may damage the bearings if contacting the rolling elements or the bearing raceway surfaces, one or more seals are provided adjacent to the raceways to exclude such contaminants. Such seal assemblies primarily function to retain lubricant, for example, oil, grease, etc., within the bearing. Further, when such wheel hub assemblies are used on an electric vehicle, it is particularly important to minimize friction within the hub assembly to reduce electric power consumption and prevent premature drainage of the vehicle batteries.

### SUMMARY OF THE INVENTION

In one aspect, the present invention is a seal assembly for retaining lubricant within a truck wheel hub assembly, the hub assembly including an inner axle with a central axis, an outer hub disposed about the axle and having a bore, the axle extending through the bore and a bearing rotatably coupling the hub with the axle such that the hub rotates about the axis. The seal assembly comprises an inner annular case disposable about the axle and having a radial portion extending radially outwardly from the axle. An outer annular case is coupleable with the hub bore and has a radial portion extending radially inwardly from the bore so as to be disposed axially between the bearing and the radial portion of the inner case. An annular elastomeric seal member has a base portion disposed on the radial portion of the outer case and at least one flexible axial seal lip with a first end integrally formed with the base portion and a second, free end sealingly engageable with the radial portion of the inner case so as to retain lubricant within the bearing. The lip extends generally axially and radially outwardly from the first end to the second end, such that the lip is biased radially outwardly by centrifugal force during rotation of the hub to reduce sealing pressure of the lip second end on the inner case radial portion.

In another aspect, the present invention is a wheel hub assembly comprising an inner axle with a central axis, an outer hub disposed about the axle and having a bore, the axle extending through the bore, a bearing rotatably coupling the hub with the axle such that the hub rotates about the axis, and a seal assembly as described in the preceding paragraph.

### BRIEF DESCRIPTION OF THE SEVERAL VIEWS OF THE DRAWINGS

The foregoing summary, as well as the detailed description of the preferred embodiments of the present invention, will be better understood when read in conjunction with the appended drawings. For the purpose of illustrating the invention, there is shown in the drawings, which are diagrammatic, embodiments that are presently preferred. It should be understood, however, that the present invention is not limited to the precise arrangements and instrumentalities shown. In the drawings:

FIG. 1 is an axial cross-sectional view of a truck hub assembly including two seal assemblies in accordance with the present invention;

FIG. 2 is a broken-away, enlarged view of a portion of FIG. 1, showing a seal member having a single axial seal lip and a radial seal lip;

FIG. 3 is an axial cross-sectional view of a seal assembly showing a seal member having first and second axial seal lips and a radial seal lip, with both axial lips sized to sealingly engage an inner case;

FIG. 4 is an axial cross-sectional view of a seal assembly showing a seal member having two axial seal lips and a radial seal lip, with a first axial lip sized to sealingly engage the inner case and a second axial lip forming a labyrinth seal gap;

FIG. 5 is an axial cross-sectional view of a seal assembly showing a seal member having three axial seal lips and a radial seal lip, with first and second axial lips sized to sealingly engage the inner case and a third axial lip forming a labyrinth seal gap;

FIG. 6 is an axial cross-sectional view of a seal assembly showing a seal member having three axial seal lips and a radial seal lip, with a first axial lip sized to sealingly engage the inner case and second and third axial lips each forming a labyrinth seal gap;

FIG. 7 is an axial cross-sectional view of a seal assembly showing a seal member having three axial seal lips, with a first and third axial lips sized to sealingly engage the inner case and a second axial lip forming a labyrinth seal gap;

FIG. 8 is an axial cross-sectional view of a seal assembly showing a seal member having three axial seal lips, with a first axial lip sized to sealingly engage the inner case and second and third axial lips each forming a labyrinth seal gap;

FIG. 9 is an axial cross-sectional view of a seal assembly showing a seal member with three axial seal lips, with first and second axial lips sized to sealingly engage the inner case and a second axial lip forming a labyrinth seal gap; and

FIG. 10 is an axial cross-sectional view of a seal assembly showing a seal member with three axial seal lips, with first and second axial lips sized to sealingly engage the inner case, a third axial lip forming an axial labyrinth seal gap and an outer case forming a radial labyrinth seal gap.

### DETAILED DESCRIPTION OF THE INVENTION

Certain terminology is used in the following description for convenience only and is not limiting. The words “inner”, “inwardly” and “outer”, “outwardly” refer to directions toward and away from, respectively, a designated centerline or a geometric center of an element being described, the particular meaning being readily apparent from the context of the description. Further, as used herein, the words “connected” and “coupled” are each intended to include direct connections between two members without any other members interposed therebetween and indirect connections between members in which one or more other members are interposed therebetween. The terminology includes the words specifically mentioned above, derivatives thereof, and words of similar import.

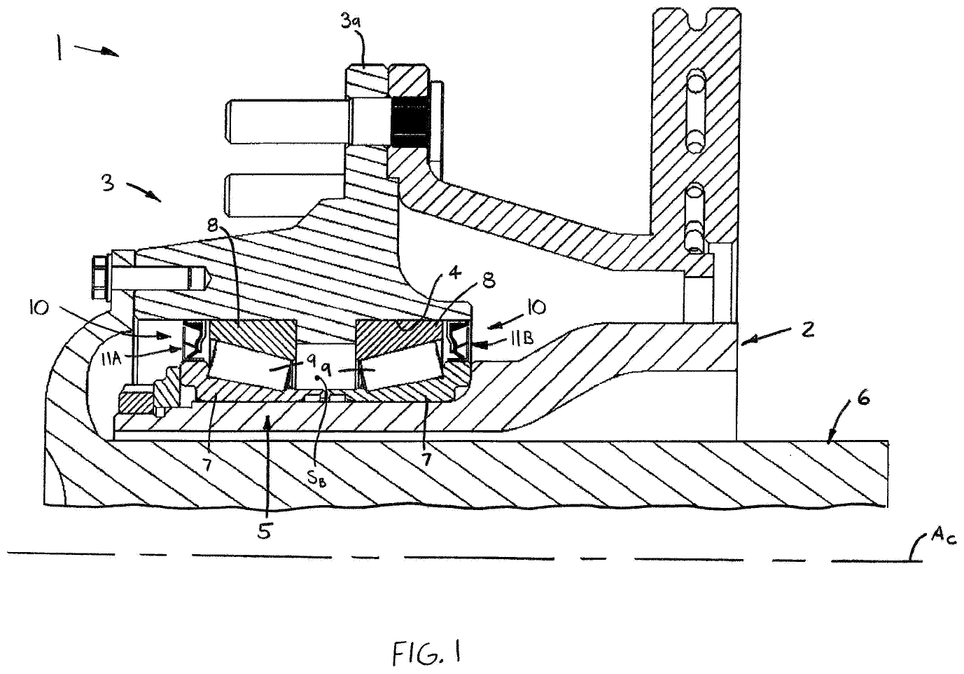

Referring now to the drawings in detail, wherein like numbers are used to indicate like elements throughout, there is shown in FIGS. 1-10 a seal assembly 10 for a truck wheel hub assembly 1, preferably for an electrically powered or “electric” truck. The hub assembly 1 includes an inner axle 2 with a central axis A_{C}, an outer hub 3 disposed about the axle 2 and having a bore 4, the axle 2 extending through the bore 4, and a bearing 5 rotatably coupling the hub 3 with the axle 2 such that the hub 3 rotates about the axis Ac. The axle 2 is fixedly connected with a vehicle frame (not shown) and the hub 3 is connected with a drive shaft 6, has a flange portion 3a connected with a wheel (not shown) and is connected with a steering mechanism and/or a suspension assembly (neither shown). The bearing 5 includes at least one inner ring 7 disposed on the axle 2, at least one outer ring 8 coupled with the hub 3, and a plurality of rolling elements 9, preferably cylindrical or tapered rollers.

The seal assembly 10 basically comprises an inner annular case 12 disposable about the axle 2, preferably connected through the bearing inner ring 7, an outer annular case 14 coupleable with the hub bore 4 and an annular elastomeric seal member 16 disposed on the outer case 14. The seal assembly 10 is configured to retain lubricant, such as oil, grease, etc., within the bearing 5, specifically within a space SB between and adjacent to the inner and outer rings 7, 8, and prevents contaminants or “substances” (e.g., brake dust, mud, etc.) from entering the bearing 5. Preferably, the seal assembly 10 is provided within the wheel hub assembly 1 as a pair of seal assemblies 10, specifically a first seal assembly 11A and a second seal assembly 11B, each seal assembly 11A, 11B being disposed on a separate, opposing axial side of the bearing 5 and defining the boundaries of the bearing space SB, as shown in FIG. 1. However, the seal assembly 10 may be provided as a single seal assembly if the hub assembly 1 is configured such that one end of the bearing 5 is enclosed by other structure (e.g., a shoulder of the axle 2).

More specifically, the inner case 12 has an axial portion 20 mountable on the axle 2 and a radial portion 22 extending radially outwardly from the axial portion 20 and from the axle 2. The axial portion 20 has an inner circumferential surface 21A defining a central bore 21 configured to receive the axle 2 and an outer circumferential surface 21B providing a radial lip contact surface 35, as described below. The radial portion 22 has an inner radial end 22a integrally connected with the axial portion 20, an outer radial end 22b, and opposing radial surfaces 23A, 23B, the inner radial surface 23A providing an axial lip contact surface 27 as discussed in further detail below.

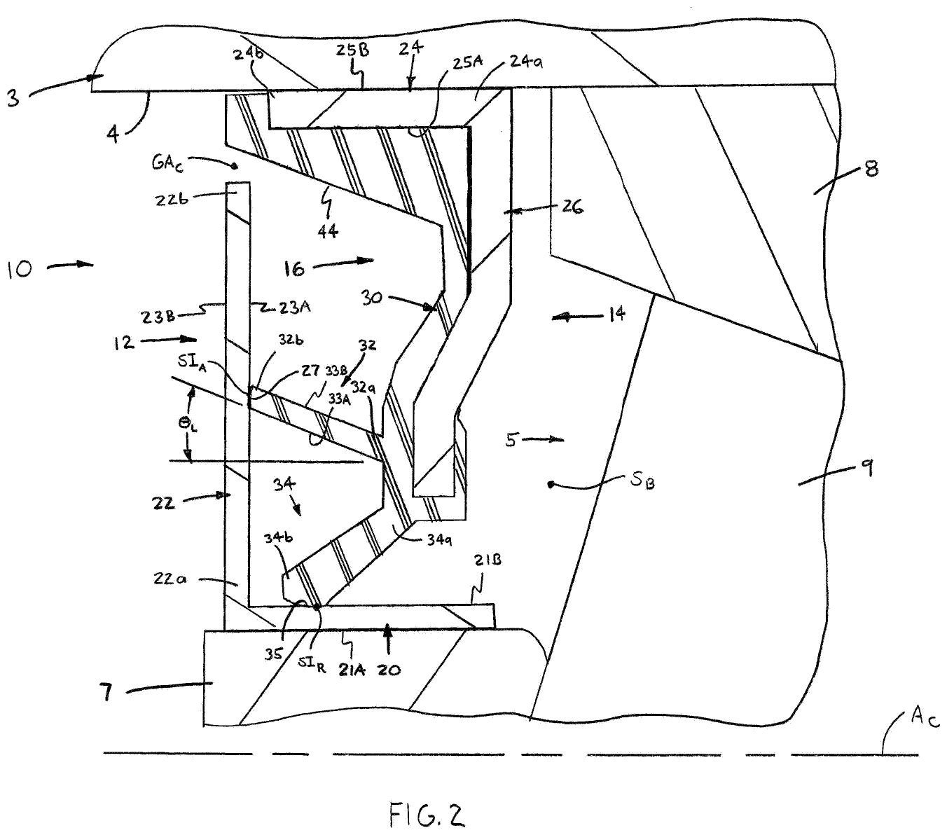

Further, the outer case 14 has an axial portion 24 engageable with the hub bore 4 and a radial portion 26 extending radially inwardly from axial portion and from the bore 4. The outer case axial portion 24 has an inner circumferential surface 25A and an opposing outer circumferential surface 25B, which is frictionally engageable with the bore 4 to couple the outer case 14 and the seal member 16 with the hub 3, and opposing first and second axial ends 24a, 24b. Furthermore, the outer case radial portion 26 extends radially inwardly from the first end of 24a of the axial portion 24. As best shown in FIG. 2, the two cases 12, 14 are relatively arranged such that the outer case radial portion 26 is disposed or disposable between the bearing 5 and the radial portion 22 of the inner case 12, for reasons discussed below. Also, the inner case radial portion 22 is generally sized, i.e., with a sufficient radial length, such that the outer radial end 22a of the inner case radial portion 22 is located generally adjacent to the second axial end 24b of the outer case axial portion 24 so as to form a radial labyrinth seal gap GA_{C}.

Further, the elastomeric seal member 16 has a base portion 30 disposed on the radial portion 26 of the outer case 14 and at least one flexible axial seal lip 32. Each axial lip 32 has a first, inner end 32a integrally formed with the base portion 30 and a second, free outer end 32b sealingly engageable with the radial portion 22 of the inner case 12 so as to be configured to retain lubricant within the bearing space SB. The at least one lip 32 extends generally axially and radially outwardly from the first end 32a to the second end 32b such that the lip 32 is biased radially outwardly by centrifugal force during rotation of the hub 3. That is, due to the radially outwardly sloped structure of the axial lip 32 as described in further detail below, centrifugal forces generated within the rotating seal member 16 cause the lip 32 to bend radially outwardly about the lip first end 32a. Such bending or deflection of the at least one lip 32 reduces sealing pressure of the lip second end 32b on the inner case radial portion 22.

More particularly, the at least one axial lip 32 is formed to both reduce sealing pressure as discussed above and to function as a “flinger” to direct substances (e.g., liquids such as water or oil, solid particles such as brake dust, dirt, etc.) away from the one or more sealing interfaces SI formed by the lips of the seal member 16. Specifically, each of the one or more axial seal lips 32 is generally frustoconical and defines an acute angle θ_{L} (FIG. 2) with respect to the central axis A_{C}, such that the lip 32 is sloped upwardly in a direction axially away from the base portion 30 of the seal member 16. Preferably, the angle θ_{L} has a value of at least thirty degrees (30°), but may be more or less steeply sloped depending on the particular application.

Further, the seal lip 32 has an inner circumferential surface 33A and an opposing outer circumferential surface 33B, each one of the circumferential surfaces 33A, 33B being angled radially outwardly in a direction from the lip first end 32a to the lip second end 32b. As such, any substances contacting the inner circumferential surface 33A or the outer circumferential surface 33B are directed generally radially outwardly along the surfaces 33A, 33B during rotation of the hub 3, and therefore away from the seal interface(s) SI. Further, due to the outer case radial portion 26 being disposed between the bearing 5 and the inner case radial portion 22, the one or more axial lips 32 each extend from the seal member base portion 30 in a direction generally axially away from the bearing 5. Due to this orientation of the axial lip(s) 32, the “flinger” action of the lips 32 tends to direct substances away from the bearing 5.

In certain constructions as shown in FIGS. 1-6, the seal member 16 further includes an annular radial seal lip 34 disposed radially inwardly of the at least one axial seal lip 32. The radial seal lip 34 extends radially inwardly from the outer case radial portion 26 and is sealingly engageable with the radial lip contact surface 35 of the inner case axial portion 20, or alternatively of the bearing inner ring 7 (or even the axle 2), so as function as the primary seal to retain lubricant within the bearing 5. Specifically, the radial lip 34 has an inner radial end 32a integrally formed with the seal member base portion 30 and an inner radial end 34b sealingly engageable with the contact surface 35. The radial seal lip 34 engages the lip contact surface 35 with a contact pressure generated solely by interference between the radial seal lip 34 and the lip contact surface 35. In other words, the radial lip 34 is not configured or constructed to be biased radially inwardly by a garter spring or similar biasing member.

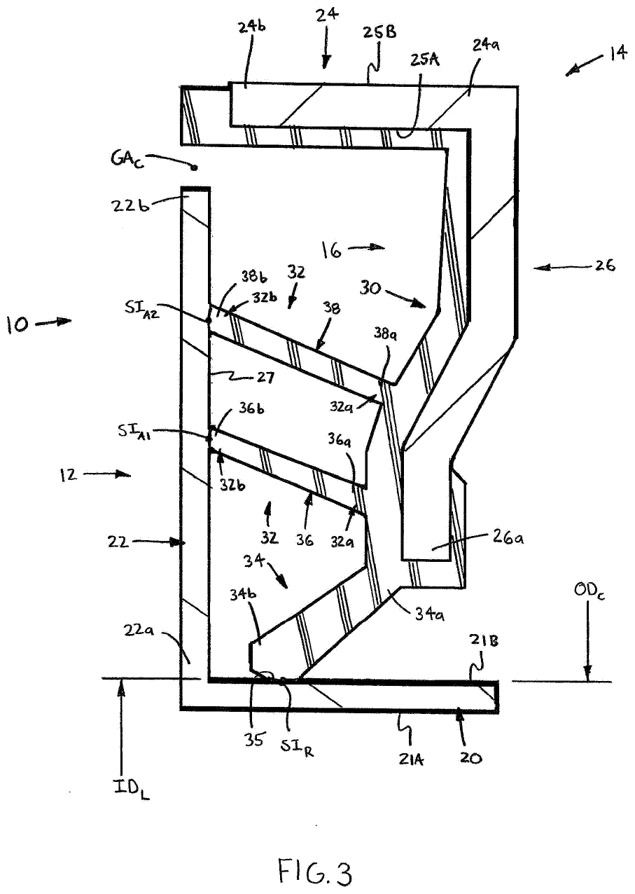

Further, the seal lip 34 is preferably sized to reduce the amount of interference between the lip 34 and the lip contact surface 35, so as to reduce the amount of friction generated by the seal assembly 10. Specifically, as indicated in FIG. 3, the radial seal lip 34 has an inside diameter ID_{L} and the lip contact surface 35 has an outside diameter OD_{C}, and the seal lip 34 is sized relative to the contact surface 35 such that the interference loading is about half of a standard radial lip seal interference.

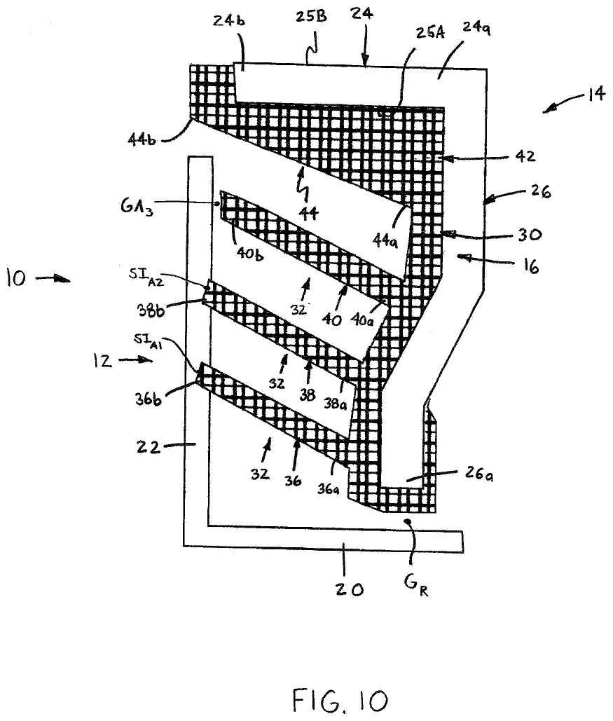

However, as shown in FIGS. 7-10, the seal assembly 10 may be constructed without any “radial” seal lip, i.e., a lip that seals radially inwardly against an outer circumferential surface or radially outwardly against and inner circumferential surface. As such, any sealing interface SI is formed solely by the one of more axial lips 32. In certain applications, the outer case 14 is formed generally conventionally such that an inner radial end 26a of the case radial portion 26 is spaced radially outwardly from the inner case 12 by a relatively large gap (not indicated), as shown in FIGS. 7-9. However, the outer case 14 may be sized with an “elongated” radial portion 26 such that the inner radial end 26a is located generally adjacent to and spaced radially outwardly from the inner case axial portion 20 (or the bearing inner ring 7 or the axle 2) so as to define a radial labyrinth seal gap GR, as depicted in FIG. 10. Such a radial labyrinth gap GR is configured to restrict lubricant flow from the bearing 5, particularly as lubricant tends to be directed radially outwardly during rotation of the hub 3, and also functions to inhibit the migration toward the bearing 5 of any substances that may pass through the seal interface(s) SI formed by the axial lip(s) 32.

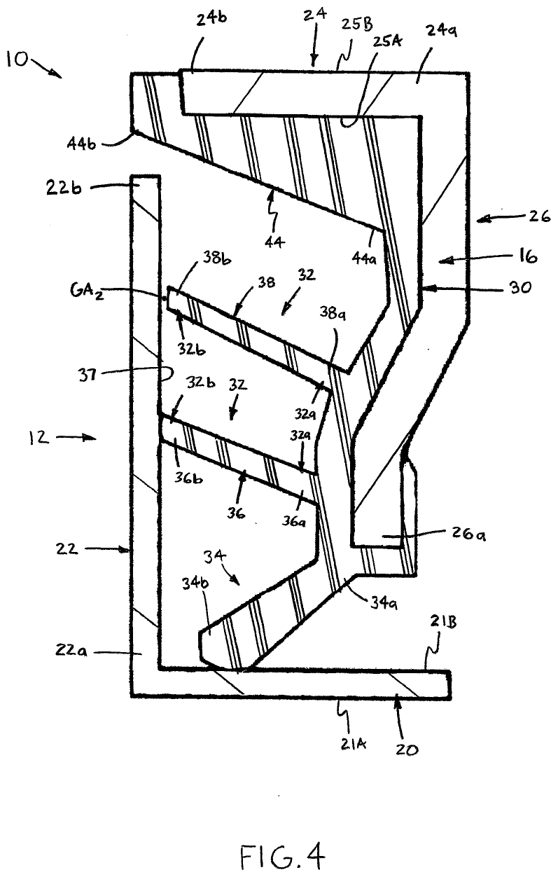

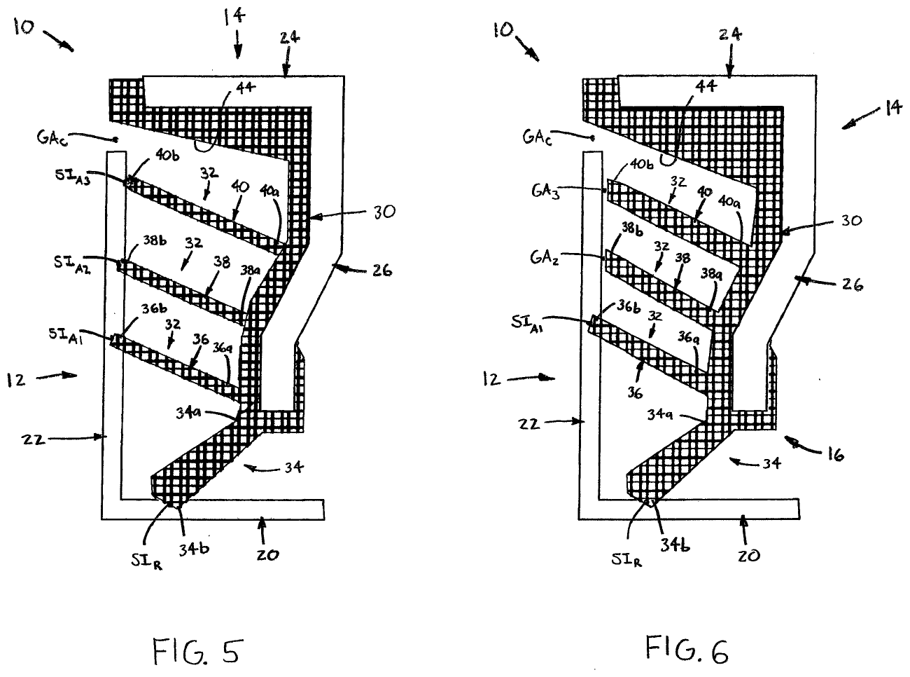

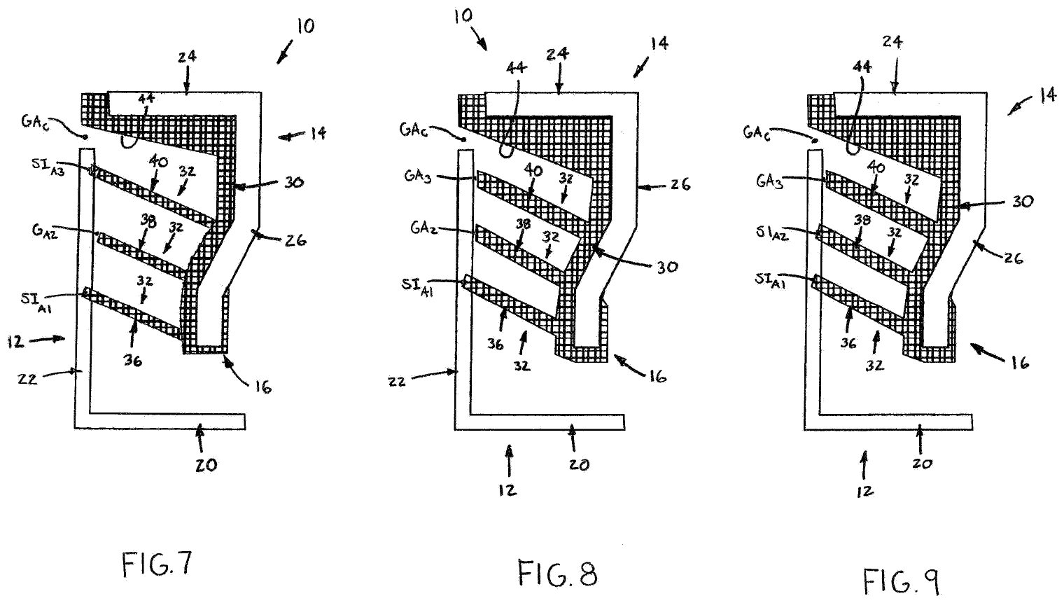

Referring to FIGS. 3-10, the seal assembly 10 may be formed having multiple axial seal lips 32, preferably either a double lip seal as shown in FIGS. 3 and 4 or a triple lip seal as depicted in FIGS. 5-10, although four or more axial lips are also within the scope of the present invention (no alternatives shown). In the double-lip embodiment, the at least one axial seal lip 32 is a first axial seal lip 36 having first and second ends 36a, 36b and the seal member 16 further includes a second flexible axial seal lip 38 spaced radially outwardly from the first axial seal lip 36. The second axial lip 38 is similarly constructed as the first lip 36 and has a first end 38a integrally formed with the seal member base portion 30, specifically at a location radially outwardly from the first end 36a of the first seal lip 36, and a second, free end 38b engaged with or spaced apart from the inner case radial portion 22. The second axial seal lip 38 extends generally axially and radially outwardly from the seal lip first end 38a to the seal lip second end 38b. As such, the second axial seal lip 38 is biased radially outwardly by centrifugal force during rotation of the hub 12 in a manner similar to the first axial lip 32.

As shown in FIG. 4, the second axial lip 38 may be configured to form a labyrinth seal, specifically by sizing the “length” of the lip 38 such that the second end 38b is spaced axially from the inner case radial portion 22 so as to define an axial labyrinth seal gap G_{A2}. Thereby, instead of directly sealing on the inner case 12, the lip 38 functions as a barrier to prevent contaminants/substances from migrating radially inwardly, except through the relatively small axial gap G_{A2}, and as a “flinger” to direct substances generally away from the sealing interface SI_{A1} formed by the first axial lip 36. Alternatively, the second axial lip 38 may function as a conventional axial sealing lip and be sized to sealingly engage with the radial portion 22 of the inner case 12, thereby creating a second axial seal lip interface SI_{A2} located radially outwardly from the interface SI_{A1} of the first axial lip 36, as shown in FIG. 3. Even in a seal assembly 10 with two axial sealing interfaces SI_{A1}, SI_{A2}, friction generated by the seal assembly 10 is substantially reduced in comparison with a conventional seal assembly due to the reduced sealing pressure within each interface SI_{A1}, SI_{A2} owing to centrifugal action on each sloped conical axial lip 32.

As discussed above, the seal assembly 10 may be fabricated with a “triple” axial lip seal member 16 as shown in FIGS. 5-10. Specifically, the seal member 16 may include a third axial seal lip 40 spaced radially outwardly from the second axial seal lip 38 and formed as the conical seal lip 32 as described above. As such, the third axial seal lip 40 has a first end 40a integrally formed with the seal member base portion 30, specifically at a location outwardly from the first end 38a of the second lip 38, and a second, free end 40b engaged with or spaced axially apart from the inner case radial portion 22. As described above, the third axial seal lip 40 also extends generally axially and radially outwardly from the seal lip first end 40a to the seal lip second end 40b, and is likewise biased radially outwardly by centrifugal force during rotation of the hub 3.

In certain constructions, the third axial lip 40 is has a length between the first and second ends 40a, 40b which is sized to form a labyrinth seal gap G_{A3} between the lip second end 40b and the inner case radial portion 22. Such a third lip gap G_{A3} may function alone as a labyrinth seal, as shown in FIGS. 9-10, or in combination with a second lip gap G_{A2} as depicted in FIGS. 6 and 8. Alternatively, the third axial lip 40 may be sized such that the second end 40b sealingly engages with the inner case radial portion 22, either in combination with both of the first and second lips 36, 38 (FIG. 5) or only with the first lip 36 and with the second axial lip 38 forming a labyrinth gap G_{A2} (FIG. 7). In any case, the third axial lip 40 is substantially formed and substantially functions as described above with the basic structure of each lip 32.

Referring now to FIGS. 2, 4 and 5-10, the seal member base portion 30 may be formed to include a “flinger” wedge section 42 disposed on the inner surface 25A of the outer case axial portion 24 and having an angled contact surface 44. As indicated in FIGS. 4 and 10, the angled surface 44 has a radially inner end 44a adjacent to the outer case radial portion 26 and a radially outer end 44b adjacent to the second axial end 24b of the outer case axial portion 24. With this structure, substances contacting the angled surface 44 are directed radially outwardly and axially away from the outer case radial portion 26, and thus away from the bearing 5, during rotation of the hub 3.

The seal assembly 10 of the present invention, in any of the particular constructions or embodiments disclosed herein, is clearly advantageous over previously known seals for wheel hub assemblies. First, by having axial lips 32 that are formed to become biased radially outwardly during rotation of the hub 4, the sealing pressure is substantially reduced in comparison with standard axial lip designs, decreasing friction within the seal assembly 10. Also, with multiple axial lips 32, sizing one or more of the lips 32 to form a labyrinth seal gap, as opposed to being in direct sealing engagement, also reduces the amount of friction generated by the seal assembly 10. Further, by forming the radial lip 34 without any biasing means, such as a garter spring, and sizing the ID of the lip 34 to minimize interference with the lip contact surface 35, friction within the seal assembly 10 is even further reduced. Finally, in embodiments without any radial seal lip, the amount of friction reduction is substantially increased.

Representative, non-limiting examples of the present invention were described above in detail with reference to the attached drawings. This detailed description is merely intended to teach a person of skill in the art further details for practicing preferred aspects of the present teachings and is not intended to limit the scope of the invention.

Moreover, combinations of features and steps disclosed in the above detailed description may not be necessary to practice the invention in the broadest sense, and are instead taught merely to particularly describe representative examples of the invention. Furthermore, various features of the above-described representative examples, as well as the various independent and dependent claims below, may be combined in ways that are not specifically and explicitly enumerated in order to provide additional useful embodiments of the present teachings.

All features disclosed in the description and/or the claims are intended to be disclosed separately and independently from each other for the purpose of original written disclosure, as well as for the purpose of restricting the claimed subject matter, independent of the compositions of the features in the embodiments and/or the claims. In addition, all value ranges or indications of groups of entities are intended to disclose every possible intermediate value or intermediate entity for the purpose of original written disclosure, as well as for the purpose of restricting the claimed subject matter. The invention is not restricted to the above-described embodiments, and may be varied within the scope of the following claims.

I claim:

1. A seal assembly for retaining lubricant within a truck wheel hub assembly, the hub assembly including an inner axle with a central axis, an outer hub disposed about the axle and having a bore, the axle extending through the bore and a bearing rotatably coupling the hub with the axle such that the hub rotates about the axis, the seal assembly comprising:
an inner annular case disposable about the axle and having a radial portion extending radially outwardly from the axle;
an outer annular case coupleable with the hub bore and having a radial portion extending radially inwardly from the bore so as to be disposed axially between the bearing and the radial portion of the inner case; and
an annular elastomeric seal member having a base portion disposed on the radial portion of the outer case and at least one flexible axial seal lip with a first end integrally formed with the base portion and a second, free end sealingly engageable with the radial portion of the inner case so as to retain lubricant within the bearing, the lip extending generally axially and radially outwardly from the first end to the second end such that the lip is biased radially outwardly by centrifugal force during rotation of the hub to reduce sealing pressure of the lip second end on the inner case radial portion.

2. The seal assembly as recited in claim 1 wherein the seal member further includes an annular radial seal lip disposed radially inwardly of the at least one axial seal lip, extending radially inwardly from the outer case and being sealingly engageable with an outer circumferential lip contact surface so as to retain lubricant within the bearing.

3. The seal assembly as recited in claim 2 wherein radial seal lip engages the lip contact surface with a contact pressure generated solely by interference between the radial seal lip and the lip contact surface.

4. The seal assembly as recited in claim 1 wherein the axial seal lip is a first axial seal lip and the seal member further includes a second flexible axial seal lip spaced radially outwardly from the first axial seal lip and having a first end integrally formed with the base portion and a second, free end engaged with or spaced apart from the inner case radial portion, the second axial seal lip extending generally axially and radially outwardly from the seal lip first end to the seal lip second end such that the second axial seal lip is biased radially outwardly by centrifugal force during rotation of the hub.

5. The seal assembly as recited in claim 4 wherein:
the second end of the second axial seal lip is spaced axially from the inner case radial portion so as to define a labyrinth seal gap; or
the second end of the second axial seal lip is sealingly engageable with the radial portion of the inner case.

6. The seal assembly as recited in 4 wherein the seal member further includes a third axial seal lip spaced radially outwardly from the second axial seal lip and having a first end integrally formed with the base portion and a second, free end engaged with or spaced apart from the inner case radial portion, the second axial seal lip extending generally axially and radially outwardly from the seal lip first end to the seal lip second end such that the third axial seal lip is biased radially outwardly by centrifugal force during rotation of the hub.

7. The seal assembly as recited in claim 1 wherein the at least one axial seal lip extends from the seal member base portion in a direction generally axially away from the bearing.

8. The seal assembly as recited in claim 1 wherein:
the inner case has an axial portion with a central bore, the axle extending through the central bore and the radial portion of the inner case extending radially outwardly from the inner case axial portion; and
the outer case has an axial portion frictionally engageable with the hub bore, the outer case radial portion extending radially inwardly from the outer case axial portion.

9. The seal assembly as recited in claim 1 wherein the at least one axial seal lip is generally frustoconical and defines an acute angle with respect to the central axis, the angle having a value of at least thirty degrees.

10. The seal assembly as recited in claim 9 wherein the at least one axial seal lip has an inner circumferential surface and an opposing outer circumferential surface, each one of the inner circumferential surface and the outer circumferential surface being angled radially outwardly in a direction from the lip first end to the lip second end such that substances contacting the inner circumferential surface or the outer circumferential surface are directed generally radially outwardly during rotation of the hub.

11. The seal assembly as recited in claim 1 wherein the radial portion of the outer case has an inner radial end located generally adjacent to and spaced radially outwardly from the inner case axial portion so as to define a labyrinth seal gap configured to restrict lubricant flow from the bearing.

12. The seal assembly as recited in claim 1 wherein:
the outer case has an axial portion with first and second axial ends, the radial portion extending inwardly from the first axial end, and an inner circumferential surface; and
the seal member base portion includes a wedge section disposed on the inner surface of the outer case axial portion and having an angled contact surface with a radially inner end adjacent to the outer case radial portion and a radially outer end adjacent to the second axial end of the outer case axial portion such that substances contacting the angled surface are directed radially outwardly and axially away from the outer case radial portion during rotation of the hub.

13. A wheel hub assembly comprising:
an inner axle with a central axis;
an outer hub disposed about the axle and having a bore, the axle extending through the bore;
a bearing rotatably coupling the hub with the axle such that the hub rotates about the axis; and
a seal assembly for retaining lubricant within the bearing and including:
an inner annular case disposable about the axle and having a radial portion extending radially outwardly from the axle;
an outer annular case coupleable with the hub bore and having a radial portion extending radially inwardly from the bore so as to be disposed axially between the bearing and the radial portion of the inner case; and
an annular elastomeric seal member having a base portion disposed on the radial portion of the outer case and at least one flexible axial seal lip with a first end integrally formed with the base portion and a second, free end sealingly engageable with the radial portion of the inner case so as to retain lubricant within the bearing, the lip extending generally axially and radially outwardly from the first end to the second end such that the lip is biased radially outwardly by centrifugal force during rotation of the hub to reduce sealing pressure of the lip second end on the inner case radial portion.

14. The wheel hub assembly as recited in claim 13 wherein the seal member further includes an annular radial seal lip disposed radially inwardly of the at least one axial seal lip, extending radially inwardly from the outer case and being sealingly engageable with an outer circumferential lip contact surface with a contact pressure generated solely by interference between the radial seal lip and the lip contact surface.

15. The wheel hub assembly as recited in claim 13 wherein the axial seal lip is a first axial seal lip and the seal member further includes a second flexible axial seal lip spaced radially outwardly from the first axial seal lip and having a first end integrally formed with the base portion and a second, free end engaged with or spaced apart from the inner case radial portion, the second axial seal lip extending generally axially and radially outwardly from the seal lip first end to the seal lip second end such that the second axial seal lip is biased radially outwardly by centrifugal force during rotation of the hub, the second end of the second axial seal lip being spaced axially from the inner case radial portion so as to define a labyrinth seal gap or sealingly engageable with the radial portion of the inner case.

16. The wheel hub assembly as recited in 15 wherein the seal member further includes a third axial seal lip spaced radially outwardly from the second axial seal lip and having a first end integrally formed with the base portion and a second, free end engaged with or spaced apart from the inner case radial portion, the second axial seal lip extending generally axially and radially outwardly from the seal lip first end to the seal lip second end such that the third axial seal lip is biased radially outwardly by centrifugal force during rotation of the hub.

17. The wheel hub assembly as recited in claim 13 wherein the at least one axial seal lip is generally frustoconical and defines an acute angle with respect to the central axis, the angle having a value of at least thirty degrees.

18. The wheel hub assembly as recited in claim 13 wherein the at least one axial seal lip has an inner circumferential surface and an opposing outer circumferential surface, each one of the inner circumferential surface and the outer circumferential surface being angled radially outwardly in a direction from the lip first end to the lip second end such that substances contacting the inner circumferential surface or the outer circumferential surface are directed generally radially outwardly during rotation of the hub.

19. The wheel hub assembly as recited in claim 13 wherein the radial portion of the outer case has an inner radial end located generally adjacent to and spaced radially outwardly from the inner case axial portion so as to define a labyrinth seal gap configured to restrict lubricant flow from the bearing.
